(19) United States
(12) Patent Application Publication
(10) Pub. No.: US 2007/0239623 A1
(43) Pub. Date: Oct. 11, 2007

(54) ELECTRONIC DEVICE USED FOR DOWNLOADING OR UPLOADING DATA

(75) Inventors: Wen-Wu Wang, Shenzhen (CN); Shih-Fang Wong, Shenzhen (CN); Tsung-Jen Chuang, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/617,694

(22) Filed: Dec. 28, 2006

(30) Foreign Application Priority Data
Apr. 5, 2006 (CN) 200610060189.9

(51) Int. Cl. H04L 9/00

(52) U.S. Cl. 705/77

(57) ABSTRACT

An electronic device allowable a portable apparatus to upload and download data is provided. The electronic device includes an interface, an input unit, a processing unit, a payment management unit, and a transfer management unit. The interface is configured for communicating with an external portable apparatus. The input unit is configured for allowing a user to select data to be downloaded or uploaded. The processing unit is configured for calculating a toll for downloading or uploading the data. The payment management unit is configured for accepting payment according to the toll calculated from the processing unit, and generating a payment received signal to signal the processing unit to generate a data transfer command. The transfer management unit is configured for transmitting the data to the external portable apparatus through the interface according to the data transfer command.

### BACKGROUND

1. Technical Field

The present invention relates to electronic devices, and particularly to an electronic device allowing a portable apparatus to download and upload data.

2. General Background

Portable electronic apparatuses, such as media players, personal digital assistants, digital cameras, and mobile phones, are common in modern society. In other words, these electronic apparatuses have become a part of most people's lives. However, the memory capacity of these electronic apparatuses may not be large enough and be limited in order to reduce a weight of the electronic apparatuses. Consequently, the memory of these electronic apparatuses may be quickly used up after storing information with large size.

In particular to the digital cameras, a high quality compressed digital photograph may easily exceed more than 1 megabyte in size. Therefore, once the memory capacity of the digital cameras is taken, it is necessary to either a) delete existing data (e.g., photographs) to free memory available for new data, or, b) upload the existing data to a personal computer. Deleting the existing data results in data loss, and uploading the existing data requires that the personal computer is conveniently accessible. However, some people (e.g., travelers) prefer to take little devices when outdoor. Consequently, these travelers seldom bring their personal computers when traveling. Therefore, it is inconvenience for these travelers to upload the data of the digital cameras.

What is needed, therefore, is an electronic device that can be equipped in the outdoor (e.g., street, shop, airport, railway station) and allow a portable apparatus to upload and download data when necessary.

### SUMMARY

An electronic device allowing a portable apparatus to upload and download data is provided. The electronic device includes an interface, a hard disk, an input unit, a screen, a processing unit, a payment management unit, and a transfer management unit.

The interface is configured for communicating with an external portable apparatus. The hard disk is configured for storing an index of downloadable data and a payment charge table, wherein the index of downloadable data is an index of data downloadable by the external portable apparatus, and the payment charge table defines fees for performing data download between the hard disk and the external portable apparatus.

The input unit is configured for receiving operational inputs including download requests. The screen is configured for displaying a menu including a download option when a state of the electronic device is in a stand-by state, and displaying a download user interface to navigate through the index of downloadable data so as to select data corresponding to requested data of the download requests if the download option is selected to change the state of the electronic device to a data download state.

The processing unit is configured for searching for the requested data of the download requests in the hard disk and obtaining data paths of the requested data of the download requests, calculating a download toll for performing the download requests referencing the payment charge table, and displaying the calculated download toll on the screen, when the electronic device is in the data download state.

The a payment management unit is configured for receiving payment according to the calculated download toll from the processing unit, and generating a payment received signal to signal the processing unit to generate a data transfer command. The transfer management unit is configured for transmitting the data to the external portable apparatus through the interface according to the data transfer command.

Other advantages and novel features will be drawn from the following detailed description with reference to the attached drawing, in which:

### BRIEF DESCRIPTION OF THE DRAWINGS

FIG. 1 is an application schematic diagram of an electronic device capable of uploading and downloading data in accordance with a preferred embodiment of the present invention;

FIG. 2 is a schematic diagram of a hardware infra of the electronic device of FIG. 1; and

FIG. 3 is a flowchart of a preferred method for transmitting data by utilizing the electronic device of FIG. 2.

### DETAILED DESCRIPTION OF THE EMBODIMENT

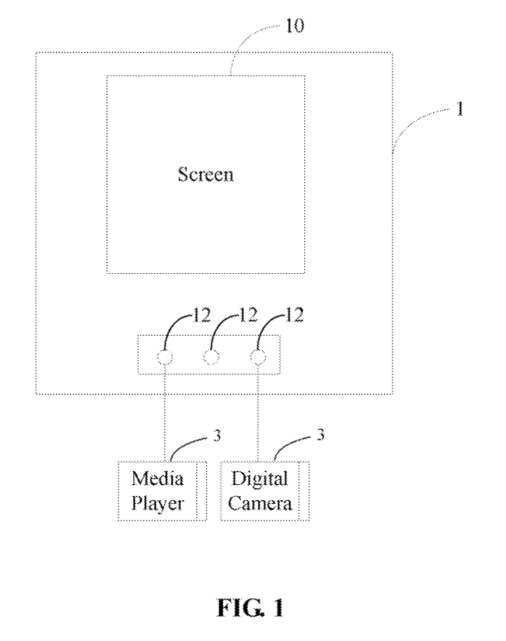

FIG. 1 is an application schematic diagram of an electronic device capable of performing data upload and/or data download in accordance with a preferred embodiment of the present invention. The electronic device 1 can be provided at any appropriate place, such as on a street, in a shop, at an airport, at a railway station, and so on. The electronic device 1 includes a plurality of interfaces 12. Each interface 12 is configured for communicating with an external portable apparatus 3, such as a portable media player, a personal digital assistant, a digital camera, and the like. The interface 12 may adopt either of or a combination of a USB (Universal Serial Bus) interface, a 1394 interface, and the like.

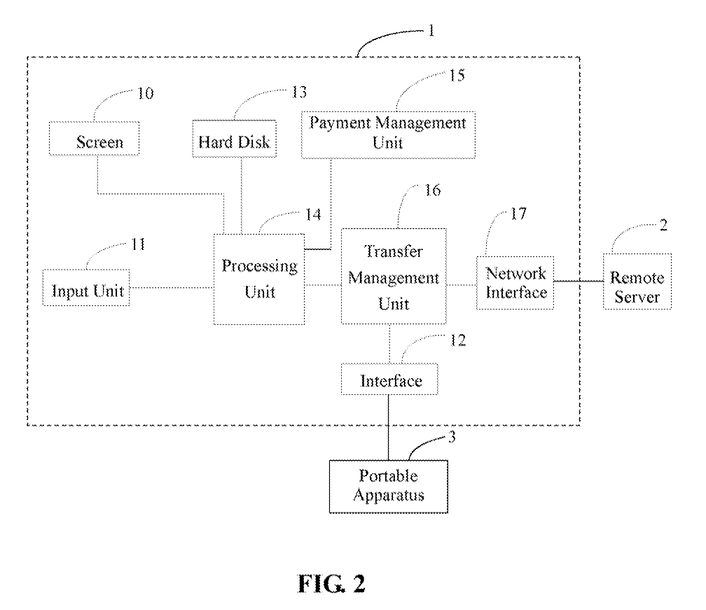

FIG. 2 is a schematic diagram of a hardware infrastructure of the electronic device 1 of FIG. 1. The electronic device 1 further includes a screen 10, an input unit 11, a hard disk 13, a processing unit 14, a payment management unit 15, a transfer management unit 16, and a network interface 17.

The hard disk 13 stores an index of downloadable files and a payment charge table. The index of downloadable files is an index of data files that the portable apparatus 3 can download from the electronic device 1. The payment charge table defines fees for performing data file download or data file upload between the hard disk 13 or a remote server 2 and the portable apparatus 3.

The input unit 11 is used for receiving operational inputs that includes download requests and upload requests.

The screen 10 is configured for displaying information. Specifically, when a state of the electronic device 1 is in a stand-by state, the screen 10 displays a menu including a download option and an upload option.

If the download option is selected when the state of the electronic device 1 is in the stand-by state, the state of the electronic device 3 changes to a file download state. In the file download state, the screen 10 displays a download user interface to navigate through the index of downloadable files so as to select files corresponding to requested files of the download requests. During the file download state, the processing unit 14 locates/finds/searches for the requested files in the hard disk 13 and obtains data paths of the requested files, if the requested files cannot be found in the hard disk 13, the processing unit 14 further sends a search request to a remote server 2 for further locating and/or receiving the requested files through the network interface 17, thus, obtaining the data paths of the requested files that are not found in the hard disk 13.

After the requested files are located, the processing unit 14 calculates a download toll for performing the download requests referencing the payment charge table, and displays the calculated download toll on the screen 10. The payment management unit 15 receives payment (e.g., a bank card or cash) according to the calculated download toll before generating a payment received signal to the processing unit 14. After receiving the payment received signal, the processing unit 14 generates a data transfer command to the transfer management unit 16. When the transfer management unit 16 receives the data transfer command while in the file download state, the transfer management unit 16 transmits the requested files of the download requests according to the data paths from either a selection and/or a combination of the hard disk 13 and the remote server 2 to the portable apparatus 3 through the interface 12.

If the upload option is selected when the state of the electronic device 1 is in the stand-by state, the state of the electronic device 3 changes to a file upload state. The screen 10 displays an upload user interface to navigate through uploadable files that are stored in the portable apparatus 3 so as to select files and obtain the data paths corresponding to requested files of the upload requests. During the file upload state, the processing unit 14 fetches the requested files from the portable apparatus 3 through the interface 12.

After the requested files are fetched, the processing unit 14 calculates an upload toll for performing the upload requests referencing the payment charge table, and displays the calculated upload toll on the screen 10. The payment management unit 15 receives payment according to the calculated upload toll before generating the payment received signal to the processing unit 14. After receiving the payment received signal, the processing unit 14 generates the data transfer command to the transfer management unit 16. When the transfer management unit 16 receives the data transfer command while in the file upload state, the transfer management unit 16 transmits (i.e., uploads) the requested files of the upload requests according to the data paths from the portable apparatus 3 to the remote server 2 through the network interface 17.

In addition, the screen 10 may be equipped with a touch panel so as to also allow the user to navigate through the index of downloadable files and to select files corresponding to requested files of the download requests, or to navigate through uploadable files that are stored in the portable apparatus 3 and to select files and obtain the data paths corresponding to requested files of the upload requests. In other words, the operational inputs can be received from the input unit 11 and/or the touch panel.

Data upload and data download between the portable apparatus 3 and the electronic device 1 or the remote server 2 can be conveniently performed at any locations provided with the electronic device 1. Hence, there would be no need to delete data to free storage space in the portable device 3 having a limited storage capacity.

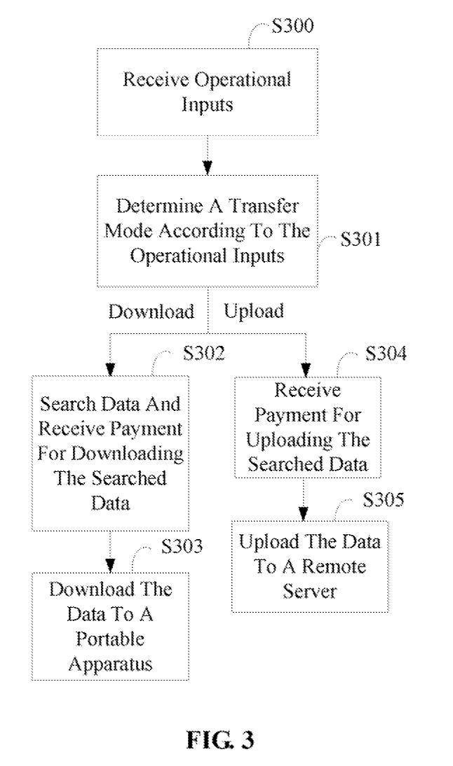

FIG. 3 is a flowchart of a preferred method for transmitting data by utilizing the electronic device 1 of FIG. 2. In step S300, the input unit 11 receives the operational inputs (i.e., the download requests or the upload requests).

In step S301, the processing unit 14 determines a transfer mode (e.g., downloading or uploading) according to the operational inputs, that is, the state of the electronic device 1 depends on the operation inputs.

If the operational inputs are the download requests, (i.e., the download option is selected), in step S302, the state of the electronic device 1 becomes the file download state. The screen 10 displays the download user interface to navigate through the index of downloadable files so as to select files corresponding to requested files of the download requests.

During the file download state, the processing unit 14 searches for the requested files in the hard disk 13 and obtains the data paths of the requested files, if the requested files cannot be found in the hard disk 13, the processing unit 14 further sends the search request to the remote server 2 for further locating and/or receiving the requested files through the network interface 17, thus, obtaining the data paths of the requested files that are not found in the hard disk 13.

After the requested files are located, the processing unit 14 calculates the download toll for downloading the searched files referencing the payment charge table, and displays the calculated download toll on the screen 10.

The payment management unit 15 receives payment according to the calculated download toll and generates the payment received signal to signal the processing unit 14.

In step S303, the processing unit 14 generates the data transfer command according to the payment received signal. The transfer management unit 16 receives the data transfer command, and transmits the requested files of the download requests according to the data paths from either the selection and/or the combination of the hard disk 13 and the remote server 2 to the portable apparatus 3 through the interface 12.

If the operational inputs are the upload requests (i.e., the upload option is selected), in step S304, the state of the electronic device 1 becomes the file upload state. The screen 10 displays the upload user interface to navigate through uploadable files that are stored in the portable apparatus 3 so as to select files and obtain the data paths corresponding to requested files of the upload requests.

During the file upload state, the processing unit 14 fetches the requested files from the portable apparatus 3 through the interface 12. After the requested files are fetched, the processing unit 14 calculates the upload toll for performing the upload requests referencing the payment charge table, and displays the calculated upload toll on the screen 10.

The payment management unit 15 receives payment according to the calculated upload toll and generates the payment received signal to signal the processing unit 14.

In step S305, the processing unit 14 generates the data transfer command according to the payment received signal. The transfer management unit 16 receives the data transfer command, and transmits the requested files of the upload requests according to the data paths from the portable apparatus 3 to the remote server 2 through the network interface 17.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. An electronic device comprising:
an interface configured for communicating with an external portable apparatus;
a hard disk configured for storing an index of downloadable data and a payment charge table, wherein the index of downloadable data is an index of data downloadable by the external portable apparatus, and the payment charge table defines fees for performing data download between the hard disk and the external portable apparatus;
an input unit configured for receiving operational inputs, the operation inputs including download requests;
a screen configured for displaying a menu including a download option when a state of the electronic device is in a stand-by state, and displaying a download user interface to navigate through the index of downloadable data so as to select data corresponding to requested data of the download requests if the download option is selected to change the state of the electronic device to a data download state;
a processing unit configured for searching for the requested data of the download requests in the hard disk and obtaining data paths of the requested data of the download requests, calculating a download toll for performing the download requests referencing the payment charge table, and displaying the calculated download toll on the screen, when the electronic device is in the data download state;
a payment management unit configured for receiving payment according to the calculated download toll from the processing unit, and generating a payment received signal to signal the processing unit to generate a data transfer command; and
a transfer management unit configured for transmitting the data to the external portable apparatus through the interface according to the data transfer command.

2. The electronic device according to claim 1, further comprising a network interface configured for communicating with a remote server.

3. The electronic device according to claim 2, wherein the payment charge table further defines fees for performing data download between the remote server and the external apparatus.

4. The electronic device according to claim 3, wherein the processing unit is further configured for sending a search request to the remote server for further receiving the requested data of the download requests through the network interface and thus obtaining data paths of the requested data that are not found in the hard disk.

5. The electronic device according to claim 2, wherein the menu displayed on the screen further includes an upload option when the state of the electronic device is in the stand-by state, the operational inputs further include upload requests, and the payment charge table further defines fees for performing data upload between the remote server and the external portable apparatus.

6. The electronic device according to claim 5, wherein the screen is further configured for displaying an upload user interface to navigate through uploadable data stored in the external portable apparatus so as to select files and obtain data paths corresponding to requested data of the upload requests if the upload option is selected to change the state of the electronic device to a data upload state.

7. The electronic device according to claim 6, wherein the processing unit is further configured for fetching the requested data of the upload requests from the portable apparatus through the interface, calculating an upload toll for performing the upload requests referencing the payment charge table, and displaying the calculated upload toll on the screen.

8. The electronic device according to claim 7, wherein the payment management unit is further configured for receiving payment according to the calculated upload toll from the processing unit.

9. The electronic device according to claim 8, wherein the transfer management unit is further configured for transmitting the requested data of the upload requests according to the data paths from the external portable apparatus to the remote server through the network interface.

10. An electronic device comprising:
an interface configured for communicating with an external portable apparatus;
an input unit configured for allowing a user to select data to be downloaded or uploaded;
a processing unit configured for calculating a toll for downloading or uploading the data;
a payment management unit configured for receiving payment according to the calculated toll from the processing unit, and generating a payment received signal to signal the processing unit to generate a data transfer command; and
a transfer management unit configured for transmitting the data to the external portable apparatus through the interface according to the data transfer command.

11. The device according to claim 10, further comprising a network interface configured for communicating with a remote server.

12. The device according to claim 11, further comprising a hard disk for storing downloadable data and a payment charge table, wherein the payment charge table defines fees for performing data download or data upload between the hard disk or the remote server and the portable apparatus.

13. The device according to claim 12, wherein the processing unit sends a search request to the remote server for further receiving the downloadable data, when the hard disk does not store the downloadable data.

14. The device according to claim 13, wherein the transfer management unit transmits the data from the remote server to the external portable apparatus.

15. The device according to claim 14, wherein the transfer management unit transmits the data from the external portable apparatus to the remote server.
